(19) United States
(12) Patent Application Publication
(10) Pub. No.: US 2024/0400115 A1
(43) Pub. Date: Dec. 5, 2024

(54) PARKING STORAGE FACILITY FOR CABLEWAY VEHICLE

(71) Applicant: Innova Patent GmbH, Wolfurt (AT)

(72) Inventor: Tobias Aichholzer, Koblach (AT)

(21) Appl. No.: 18/676,951

(22) Filed: May 29, 2024

(30) Foreign Application Priority Data
May 31, 2023 (AT) A50427/2023

(51) Int. Cl. B61B 12/02; B61B 10/02

(52) U.S. Cl. CPC B61B 12/024; B61B 10/022

(57) ABSTRACT

A parking storage facility for cableway vehicles of a circulating cableway includes a parking conveyor with a continuous conveyor in longitudinal parking track sections and a tire conveyor in a parking track curve section, wherein a tire conveying speed of the tire conveyor increases in a first overlap region during transition from a first longitudinal parking track section to the parking track curve section to accelerate the cableway vehicle with the tire conveyor. Concurrently, the engagement of a pusher dog on the cableway vehicle is released, and the tire conveying speed of the tire conveyor decreases in a second overlap region during transition from the parking track curve section to a second longitudinal parking track section to decelerate the cableway vehicle. Concurrently, a pusher dogs on a traction means of the continuous conveyor engages the cableway vehicle.

### CROSS REFERENCES

This application claims priority to Austrian Application No. A50427/2023, filed May 31, 2023, the entire disclosure of which is hereby incorporated by reference herein.

### TECHNICAL FIELD

The present disclosure relates to a parking storage facility for cableway vehicles and a method for storing a cableway vehicle in a parking storage facility.

### BACKGROUND

Usually, circulating cableways have a number of cableway stations, a number of cableway vehicles, and a conveyor cable for moving the cableway vehicles between the cableway stations. The conveyor cable circulates between the cableway stations, for example on sheaves in the cableway stations, wherein at least one sheave is driven. Circulating cableways are also known in which the cableway vehicles are uncoupled from the conveyor cable in a cableway station in order to be moved through the cableway station in the uncoupled state and independently of the conveyor cable. Before exiting the cableway station, the cableway vehicles are accelerated back up to the speed of the conveyor cable and coupled to the conveyor cable. On the one hand, this allows for a high conveying capacity to be achieved due to the high conveying speed of the conveyor cable and on the other hand, the speed of the cableway vehicles within the cableway station can be reduced, making it easier for passengers to board and exit the cableway vehicle or, in general, for the cableway vehicles to be loaded and unloaded. Normally, at least one guide rail is provided within the cableway station for this purpose, along which the cableway vehicles are guided through the cableway station when decoupled from the conveyor cable. Rollers are usually arranged on the cableway vehicles, for example on the hanger, with which rollers the cableway vehicles roll on the guide rail. A station conveyor is provided for conveying the uncoupled cableway vehicles in a cableway station. The station conveyor can be designed as a known tire conveyor, in which driven tires arranged along the guide rail in the cableway station interact with a friction lining on the cableway vehicles. The friction lining can be arranged on the hanger of the cableway vehicle, for example. However, the station conveyor can also be designed differently, for example as a mechanical continuous conveyor with a traction means (for example a belt or chain) on which pusher dogs are provided which interact with a portion of a cableway vehicle in order to move it at the speed of the traction means. All cableway vehicles on the traction means are thus moved at the same speed as the traction means.

Such circulating cableways with cableway vehicles that can be uncoupled from the conveyor cable often also have a parking storage facility in which the cableway vehicles uncoupled from the conveyor cable can be parked outside the operating hours of the circulating cableway. As a result, maintenance work can be carried out on the conveyor cable or cableway vehicles, for example, and the cableway vehicles can be protected from weather conditions, such as snow, ice, storm, etc. Also, a number of cableway vehicles can be parked in the parking storage facility during operation of the circulating cableway, for example during times when there is little demand for transportation. Such a parking storage facility is usually located within or in the region of one of the cableway stations, for example at the same level as the operating area in which the entry and/or exit area for passengers is located, or also in a garage below the operating area. In order to bring the cableway vehicles to their intended parking positions in the parking storage facility, a parking conveyor is generally provided which can comprise one or more conveying devices. The parking conveyor is usually connected to the station conveyor in order to transfer cableway vehicles from the station conveyor to the parking conveyor, or vice versa. Switches can also be provided for this purpose in order to move cableway vehicles from the station conveyor to the parking conveyor, or vice versa. Exemplary parking conveyors are known from EP 711 696 A1 or AT 392 766 B.

Movement of the cableway vehicles in the parking storage facility often takes place on so-called sloping tracks as a parking conveyor or part of a parking conveyor. A sloping track is essentially designed in the same way as the guide rail of the cableway station but has a certain fixed slope. The cableway vehicles move along the sloping track to the parking position using only gravity due to the defined slope, without an external drive. The sloping track can be connected to the guide rail of the cableway station for example via a switch so that, for parking, the cableway vehicles can be removed from the guide rail and moved to the sloping track via the switch. The return transport of the cableway vehicles from the parking storage facility to the operating area can be carried out, for example, with a tire conveyor similar to the drive of the cableway vehicles along the guide rail in the operating area of the cableway station. However, a sloping track has a number of disadvantages. On the one hand, a sloping track is susceptible to faults, because an insufficient slope of the sloping track and/or unevenness, foreign objects, dirt, ice, etc. on the sloping track or on the cableway vehicles can lead to unintentional movement of the cableway vehicle, such as an unwanted stop, a movement that is too slow or too fast, etc., or to blocking of the cableway vehicles. On the other hand, too great a slope can cause the cableway vehicles to collide with each other at too high a speed, which can lead to damage to the cableway vehicles. Also, construction of the cableway station is quite complex due to the difference in level required for the sloping track, and installation of the sloping track is also quite difficult because the slope must be set as precisely as possible for the reasons mentioned above.

A parking storage facility often also includes parking tracks that are arranged parallel to each other: the cableway vehicles are moved to the parking tracks via a feeder track that connects the parking tracks with each other. An example of this is described in WO 2010/082125 A1 or AT 392 766 B. The disadvantage of such parking storage facilities is that a switch is required for each parking track in order to move a cableway vehicle from the feeder track to the parking track, or vice versa, which adds to the effort involved.

AT 392 766 B provides for a continuous conveyor on the feeder track as a parking conveyor and the cableway vehicles are moved on the parking tracks by self-propelled cableway vehicle receivers. However, the design is very complex because there has to be a separate cableway vehicle receiver with its own drive for each cableway vehicle.

WO 2010/082125 A1 provides for a tire conveyor on the feeder track and for a continuous conveyor on the parking track, wherein the continuous conveyor is driven by the movement of the cableway vehicle on the tire conveyor. For this purpose, the tire conveyor and the continuous conveyor overlap slightly. However, such a parking conveyor is susceptible to faults. Due to slippage errors in the tire conveyor and due to distance errors of the cableway vehicles on the tire conveyor, the drive of the continuous conveyor on the parking track can easily be interrupted.

In order to eliminate the disadvantage in a design of a parking storage facility having a feeder track and parking tracks, it is already known to provide a continuous parking track in the parking storage facility. The parking track is meander-shaped and the cableway vehicles are lined up one behind the other on the meander-shaped parking track. For reasons of space, the cableway vehicles on the parking track should of course be as close together as possible. To save space, the individual branches of the meander-shaped parking track are also arranged as close together as possible. However, the meandering arrangement of the parking track requires curved connections with small radii between neighboring parallel branches of the parking track. Cableway vehicles with large widths (transverse to the conveying direction) are often used on circulating cableways to increase the conveying capacity. However, a cableway vehicle deflects on a curved section, which is why cableway vehicles traveling one behind the other in a curved section require a certain distance in the conveying direction in order to avoid collisions. This, in turn, would require a large distance between neighboring cableway vehicles on the parking track, in particular for cableway vehicles having a large width, which, in turn, would disadvantageously increase the space required for the parking storage facility considerably.

There is therefore a need for a space-saving parking storage facility for cableway vehicles of a circulating cableway with a meander-shaped parking track and a parking conveyor and for a corresponding method for storing a cableway vehicle in such a parking storage facility.

### SUMMARY

Embodiments according to the present disclosure of the parking storage facility, in particular of the parking conveyor of the parking storage facility, makes it possible to move cableway vehicles on the longitudinal sections of the parking track at very close distance one behind the other, thus saving space. In order to avoid a collision of the cableway vehicles on the parking track curve section despite these short distances, the cableway vehicles are accelerated at the transition to the parking track curve section in order to increase the distance. After passing the parking track curve section, the cableway vehicles are decelerated again to reduce the distance again so that the cableway vehicles can continue to move at a close distance on the following longitudinal parking track section.

It is particularly advantageous if a continuous conveyor having the same traction means is provided for the first longitudinal parking track section and the second longitudinal parking track section, and optionally also for other longitudinal parking track sections. This can simplify the design of the parking conveyor because only one continuous traction means, and therefore only one drive for the traction means, is required.

A particularly smooth transition from the parking track curve section to a longitudinal parking track section can be achieved if at least one tire of the tire conveyor in the second overlap region, preferably in the region of the end or at the end of the second overlap region, is driven via a slip clutch and/or if at least one tire of the tire conveyor in the first overlap region, preferably in the region of the beginning or at the beginning of the first overlap region, is driven via a slip clutch.

In an advantageous simple embodiment, the pusher dog is U-shaped with two protruding legs, whereby an engagement region is formed between the legs in an entrainment position, in which a portion of the cableway vehicle comes to rest during operation of the parking storage facility in order to bring the pusher dog into engagement with the cableway vehicle. This enables simple engagement between the dog and the cableway vehicle.

Engagement or disengagement can be carried out particularly gently if a roller is rotatably mounted on the free axial end of at least one protruding leg.

If at least one protruding leg of the pusher dog is rotatably mounted on an axial end of the leg opposite the axial free end, wherein a spring element is provided on the pusher dog which presses the rotatably mounted leg into the entrainment position, the engagement can be realized very easily because the cableway vehicle folds the leg down by its own movement and because the folded leg straightens up again and entrains the cableway vehicle after a portion of the cableway vehicle has reached its position between the legs.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 shows a cableway station with a parking storage facility according to an embodiment of the present disclosure.

FIG. 2 shows a hanger of a cableway vehicle according to FIG. 1.

FIG. 3 shows a parking track according to the present disclosure with a parking conveyor.

FIG. 4 shows an embodiment of a pusher dog and continuous conveyor.

FIG. 5 shows the deflection of a cableway vehicle in a parking track curve section.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

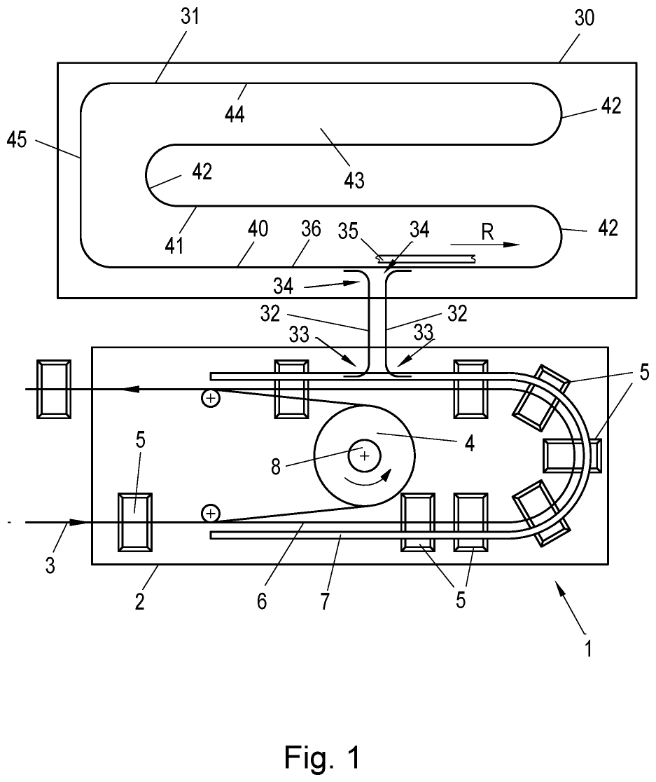

FIG. 1 shows a very schematic representation of a cableway station 2 of a circulating cableway 1. The circulating cableway usually has a second cableway station, which is not shown in FIG. 1. A conveyor cable 3 circulates between the cableway stations 2, for example on sheaves 4 in the cableway stations 2, wherein at least one sheave 4 is driven by a cableway drive 8. Cableway vehicles 5, such as gondolas or chairs, are transported on the conveyor cable 3 between the cableway stations 2. In a cableway station 2, the cableway vehicles 5 are uncoupled from the conveyor cable 3 in a known manner after entering the cableway station 2. Before exiting the cableway station 2, the cableways 5 are re-coupled to the conveyor cable 3. Cable clamps 23 on the cableway vehicles 5 are used for uncoupling and coupling. At least one guide rail 6 is provided in the cableway station 2, along which the cableway vehicles 5 are guided in the cableway station 2. A station conveyor 7, for example a tire conveyor or a continuous conveyor, is provided for moving a cableway vehicle 5, that has been uncoupled from the conveyor cable 3, in the cableway station 2 along the guide rail 6.

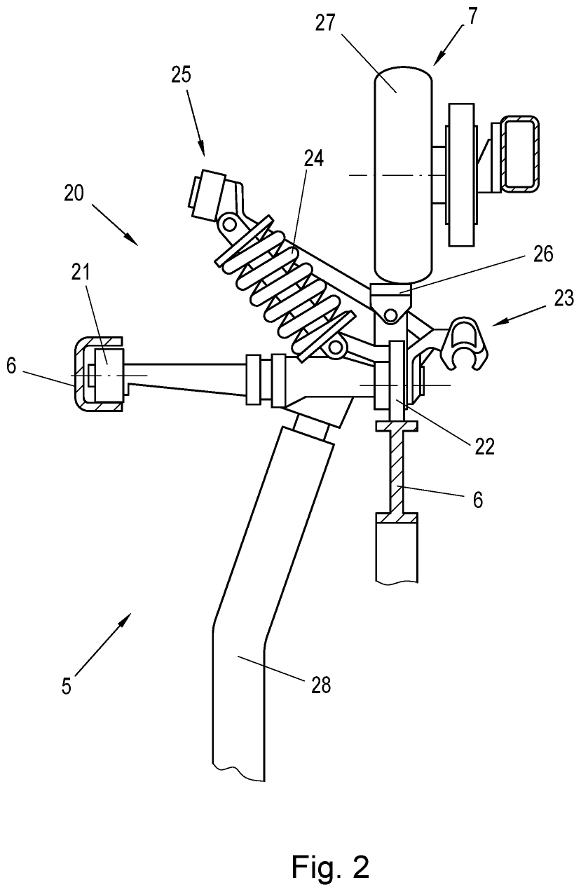

FIG. 2 shows, by way of example, a hanger 20 of a cableway vehicle 5 with which the cableway vehicle 5 hangs on the conveyor cable 3 and is moved along guide rails 6 in the cableway station 2. The hanger 20 is connected in a known manner to a transportation device (not shown) of the cableway vehicle 5, such as a cabin or a chair, with at least one hanger rod 28. A cable clamp 23 is arranged on the hanger 20, which cable clamp can clamp the conveyor cable 3 when a clamping spring 23 acts thereon and which can be actuated mechanically via clamp actuation 25 for opening. Also, at least one guide roller 21, 22 is arranged on the hanger 20, which interacts with at least one guide rail 6 in the cableway station 2 in order to guide the cableway vehicle 5 in the cableway station 2 along the at least one guide rail 6. In this exemplary embodiment, the station conveyor 7 is designed as a tire conveyor having a plurality of driven tires 27 rotatably mounted in the cableway station 2 one behind the other in the conveying direction. The tires 27 interact with a friction lining 26 on the hanger 20 to move the cableway vehicle 5, which is uncoupled from the conveyor cable 3, through the cableway station 2 by rotating the tires 27 along the guide rail 6.

A parking storage facility 30 for cableway vehicles 5 is also provided on the circulating cableway 1, in which cableway vehicles 5 can be stored. The parking storage facility 30 comprises a meander-shaped parking track 31 for accommodating cableway vehicles 5.

A feeder track 32 can be provided to transfer cableway vehicles 5 moving in the cableway station 2 to the parking storage facility 30, as shown in FIG. 2. The feeder track 32 is connected at one end to the station conveyor 7 via a station switch 33, and at the opposite end to the parking track 31 via a parking switch 34. By switching the station switch 33, a cableway vehicle 5 can be moved to the feeder track 32 and on to the parking track 31 by the station conveyor 7. If necessary, a cableway vehicle 5 can be moved from the parking track 31 to the feeder track 32 and on to the station conveyor 7 via the parking switch 34. Instead of a separate feeder track 32, however, the parking track 31 could also be connected directly to the station conveyor 7 via the station switch 32, which would eliminate the need for a parking switch 34. To move a cableway vehicle 5 along the parking track 31, a parking conveyor 35 is provided, which is indicated only for a short section in the conveying direction R in FIG. 1, but which extends of course along the entire portion of the parking track 31 used by cableway vehicles 5.

In the exemplary embodiment of FIG. 1, a second feeder track 32 is provided which, in turn, is connected to the station conveyor 7 via a station switch 33 and to the parking track 31 via a parking switch 34. The second feeder track 32 could also be omitted when connecting the parking track 31 directly to the station conveyor 7 via the station switch 33.

Using two feeder tracks 32 or two station switches 33 connected to the parking track 31 has the advantage that loading and unloading can take place on different routes and the cableway vehicles 5 only have to be moved in one direction.

For the present disclosure, however, it is of secondary importance how the parking track 31 is connected to the station conveyor 7 in the cableway station 2, as the present disclosure relates to the design of the parking storage facility 30, in particular to the design of the parking conveyor 35.

The parking track 31 according to the present disclosure of the parking storage facility 30 has at least a first longitudinal parking track section 40 and at least a second longitudinal parking track section 41, which are arranged next to each other at a distance transverse to the conveying direction R. To form a meander-shaped parking track 31, the first longitudinal parking track section 40 and the second longitudinal parking track section 41 are connected to each other via a first parking track curve section 42. A longitudinal parking track section 40, 41 is a substantially straight section of parking track 31. Preferably, the first longitudinal parking track section 40 and the second longitudinal parking track section 41 are parallel to each other, at least in sections. The first parking track curve section 42 can be circular, but can also have a different curve.

In the exemplary embodiment according to FIG. 1, more than two longitudinal parking track sections 40, 41, 43, 44, specifically four longitudinal parking track sections, are provided transversely to the conveying direction R next to each other and at a distance from one another, wherein always two adjacent longitudinal parking track sections 40, 41, 43, 44 are connected to each other alternately at different ends of the longitudinal parking track sections 40, 41, 43, 44 via a parking track curve section 42 in order to realize a continuous meander-shaped parking track 31. However, the individual parking track curve sections 42 do not necessarily have to have the same design. In order to realize a closed parking track 31, the two outer longitudinal parking track sections 40, 44 can be connected to each other via a further parking track curve section 45. However, it may also be provided for the first longitudinal parking track section 40 to be connected to a feeder track 32 or directly to the station conveyor 7 and for the last longitudinal parking track section 40 to be connected to a further feeder track 32 or directly to the station conveyor 7.

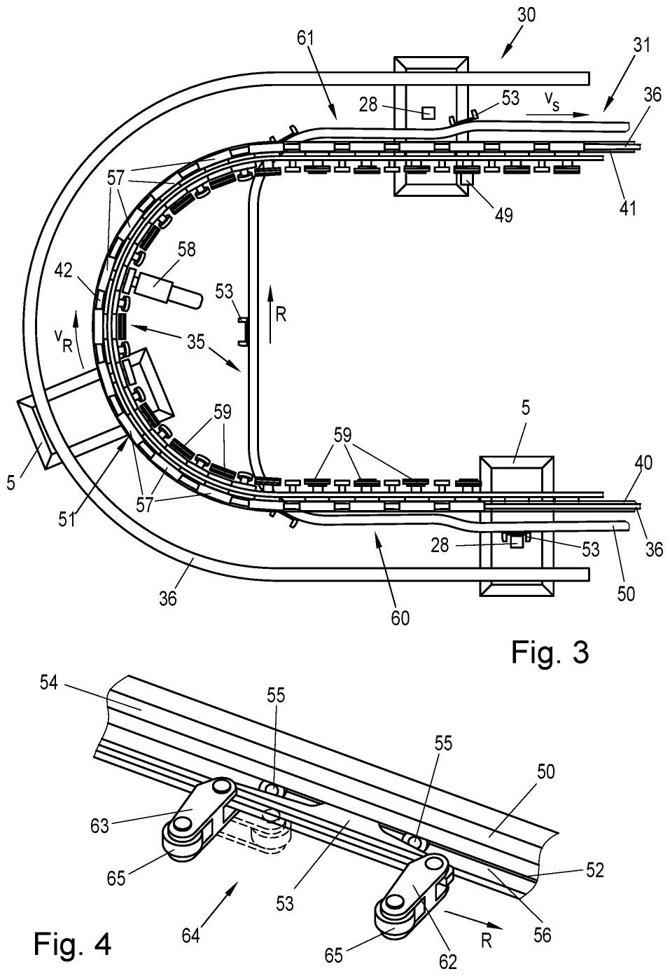

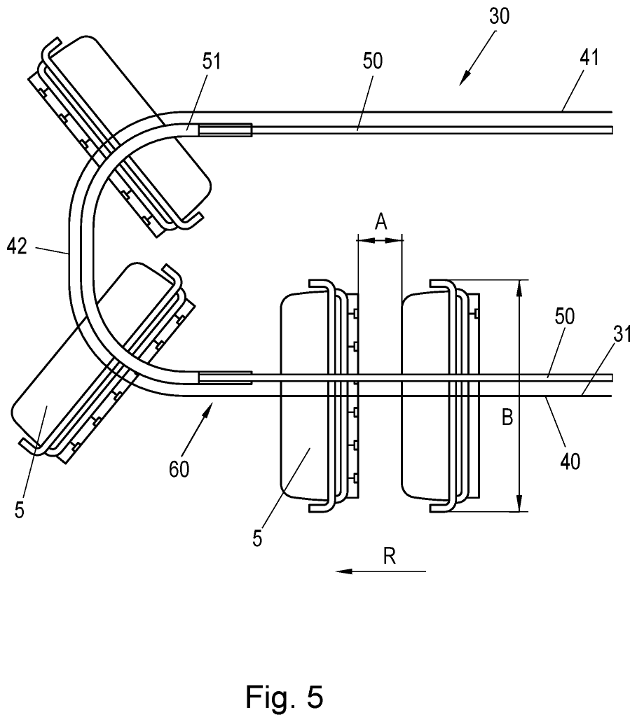

With reference to FIGS. 3 and 4, the parking conveyor 35 according to the present disclosure of the parking storage facility 30 with a parking track 31 is described. Shown is a portion of a first longitudinal parking track section 40 and a portion of a second longitudinal parking track section 41, which are connected to each other by a first parking track curve section 42.

A parking conveyor 35 is provided in the parking storage facility 30 to move a cableway vehicle 5 along the parking track 31. The parking conveyor 35 comprises a continuous conveyor 50 and a tire conveyor 51.

The continuous conveyor 50 comprises at least one traction means 52 (FIG. 3), which during operation of the parking storage facility 30 circulates in a conveying direction R at a given continuous conveying speed v_{S}. A plurality of pusher dogs 53 are arranged on the traction means 52, which are moved along with the traction means 52 at the continuous conveying speed v_{S}. A pusher dog 53 interacts with a portion of the cableway vehicle 5, for example with the hanger rod 28 as in FIG. 3, in order to move the cableway vehicle 5. For this purpose, the pusher dog 53 can simply rest against a portion of the cableway vehicle 5 or be otherwise connected to a portion of the cableway vehicle 5. The continuous conveyor 50 is configured to move a cableway vehicle 5 in the conveying direction R with the pusher dogs 53 and at a continuous conveying speed v_{S} along the longitudinal parking track sections 40, 41 during operation of the parking storage facility 30.

In the embodiment according to FIGS. 3 and 4, the traction means 52 is arranged in a one-sided open traction means housing 54. Rotatably mounted traction means rollers 55 are arranged on the traction means 52, or on the pusher dog 53 of the traction means 52, which rollers roll on a rolling surface 56 of the traction means housing 54. However, such a design of the continuous conveyor 50 is by no means mandatory. The continuous conveyor 50 can also have a conveyor belt or a conveyor chain as traction means 52, which circulate on conveyor discs and on which pusher dogs 53 are arranged.

The continuous conveyor 50 in the embodiment according to FIG. 3 is arranged in the region of the first longitudinal parking track section 40 and in the region of the second longitudinal parking track section 40 in order to move a cableway vehicle 5 along these sections. In such an embodiment, the continuous conveyor 50 is also arranged in a meandering manner. However, it would also be possible to provide a continuous conveyor 50 with separate traction means 52 for the first longitudinal parking track section 40 and the second longitudinal parking track section 40, and also for further longitudinal parking track sections 43, 43. It is also possible for a continuous conveyor 50 with the same traction means 52 to be concurrently arranged in the region of more than two longitudinal parking track sections 40, 41, 43, 44, even in the region of all longitudinal parking track sections 40, 41, 43, 44. In such an embodiment, the continuous conveyor 50, too, would be arranged in a meandering manner along the associated longitudinal parking track sections 40, 41, 43, 44.

In the embodiment according to FIG. 3, the continuous conveyor 50 could therefore run at the opposite end of the longitudinal parking track sections 40, 41 in the direction of a further longitudinal parking track section 43 adjacent transversely to the conveying direction R, so that the traction means 52 of the continuous conveyor 50 moves a cableway vehicle 5 also on this further longitudinal parking track section 43. The cableway vehicles 5 would be moved in the same direction on the first longitudinal parking track section 41 and the further longitudinal parking track section 43 and would be moved in the opposite direction in the in-between longitudinal parking track section 41. This can be provided for any number of longitudinal parking track sections.

Due to the meander-shaped parking track 31, the conveying directions R on two adjacent longitudinal parking track sections 40, 41 are opposite. This circumstance can be advantageously used by employing a continuous conveyor 50 with a single traction means 52 for both, or also for more than two, longitudinal parking track sections 40, 41, as in the embodiment according to FIG. 3. The circulating traction means 52 of the continuous conveyor 50 then moves along the two, or also along more than two, longitudinal parking track sections 40, 41 alternately in opposite directions. The cableway vehicles 5 are thus moved on the two, or even more than two, longitudinal parking track sections 40, 41 by the same traction means 52. Alternatively, but equivalently, a continuous conveyor 50 with separate traction means 52 with pusher dog 53 could also be used, wherein one traction means 52 is provided per assigned longitudinal parking track section(s) 40, 41.

The tire conveyor 51 of the parking conveyor 35 is provided in the region of the first parking track curve section 42 in order to move a cableway vehicle 5 along the parking track curve section 42. The tire conveyor 51 has a plurality of driven tires 57 arranged one behind the other in the conveying direction R. The tire conveyor 35 is configured to move a cableway vehicle 5 in the conveying direction R with the driven tires 57 and at a tire conveying speed v_{R} along the first parking track curve section 42 during operation of the parking storage facility 30.

To move the cableway vehicle 5, the tires 57 interact in a known manner with a friction lining 26 on the hanger 20 of the cableway vehicle 5, for example as shown in FIG. 2.

The tires 57 can be driven individually or in groups or all together.

In the embodiment according to FIG. 3, a tire drive 58, for example an electric motor possibly also with a gearbox, is provided, which drives a tire 57 of the tire conveyor 51. Each tire 57 has a double pulley 59 arranged thereon. Each double pulley 59 (except the last one in each case) is connected to both adjacent tires 57 with double pulley 59 by a belt, such as a V-belt or toothed belt (not shown in FIG. 3 for reasons of clarity). The tire drive 58 thus drives all tires 57. Selection of the pulley diameters makes it also possible to easily implement increases or reductions in the rotational speeds of the tires 57, and thus also different tire conveying speeds v_{R} in the region of the tires 57 of the tire conveyor 51. However, it is also conceivable for each tire 57 to be driven individually by a tire drive 58.

In order to ensure a continuous drive by the parking conveyor 35, the continuous conveyor 50 and the tire conveyor 51 overlap in a first overlap region 60 in the region of the transition from the first longitudinal parking track section 40 to the parking track curve section 42 and in a second overlap region 61 in the region of the transition from the parking track curve section 42 to the second longitudinal parking track section 41.

The basic problem with a meander-shaped parking track 31 is explained on the basis of FIG. 5. On a longitudinal parking track section 40, 41, cableway vehicles 5 can be moved even when at a very close distance to each other in the conveying direction R. Therefore, the distance A in the conveying direction R between two adjacent cableway vehicles 5 can be kept very small in order to keep the construction area of the parking storage facility 30 small. However, due to a width B of the cableway vehicles 5 transverse to the conveying direction R, the cableway vehicles 5 deflect in the parking track curve section 42, which in case of a small distance A would lead to a collision between two adjacent cableway vehicles 5, which must be prevented by all means. This is why, until now, distance A on the longitudinal parking track section 40 before the parking track curve section 42 had to be large enough to prevent a collision despite the deflection. However, this inevitably results in a larger construction area for the parking storage facility 30.

This problem is solved by this present disclosure. For this purpose, it is provided according to the present disclosure that during transition from the first longitudinal parking track section 40 to the first parking track curve section 42, the tire conveying speed v_{R} of the tire conveyor 51 increases in the first overlap region 60 in order to accelerate a cableway vehicle 5 with the tire conveyor 51 relative to the continuous conveying speed v_{S} at the continuous conveyor 50 during operation of the parking storage facility 30. The tire conveying speed v_{R} of the first tire 57 in the first overlap region 60 advantageously corresponds to the continuous conveying speed v_{S} of the continuous conveyor 50 and increases with each subsequent tire 57 in the first overlap region 60. At the same time, in the first overlap region, preferably at the beginning of the first overlap region 60, engagement of the pusher dog 63 with the cableway vehicle 5 is released so that the cableway vehicle 5 is driven only by the tire conveyor 51, at least at the end of the first overlap region 60. During transition from the first parking track curve section 42 to the second longitudinal parking track section 41, the tire conveying speed v_{R} of the tire conveyor 51 is reduced in the second overlap region 61 in order to decelerate a cableway vehicle 5 with the tire conveyor 51 during operation of the parking storage facility 30. The tire conveying speed v_{R} of the last tire 57 in the second overlap region 61 advantageously corresponds to the continuous conveying speed v_{S} of the continuous conveyor 50. At the same time, a pusher dog 53 on the traction means 52 of the continuous conveyor 50 is brought into engagement with the cableway vehicle 5 so that the cableway vehicle 5 is only moved by the continuous conveyor 51, at least at the end of the second overlap region 61.

In order to release the pusher dog 53 from engagement with the cableway vehicle 5, the continuous conveyor 51 can be displaced at the beginning of the first overlap region 60 transversely to the conveying direction R and away from the cableway vehicle 5, as shown in FIG. 3, so that the pusher dog 53 loses engagement with the cableway vehicle 5 solely due to the lateral displacement. The procedure can be reversed at the second overlap region 61, as shown in FIG. 3. At the end of the second overlap region 61, the continuous conveyor 51 is displaced transversely to the conveying direction R and towards the cableway vehicle 5 so that a pusher dog 53 on the traction means 52 comes into engagement with a portion of the cableway vehicle 5.

By accelerating a cableway vehicle 5 in the first overlap region 60 relative to the continuous conveying speed v_{S} of the traction means 52, the distance A between two adjacent cableway vehicles 5 at the first longitudinal parking track section 40 is increased. By selecting the acceleration and the achieved tire conveying speed v_{R} at the end of the first overlap region 60, the distance A can be increased such that a collision of the cableway vehicles 5 deflecting at the parking track curve section 42 is reliably avoided.

Acceleration in the first overlap region 60 can be realized, for example, by appropriately selecting the sheave diameters of the double pulleys 59 of the tires 57 in the region of the first overlap region 60, or by individually driven tires 57 in the first overlap region 60.

By decelerating a cableway vehicle 5 in the second overlap region 61, the speed of the cableway vehicle 5 can be adapted again to the continuous conveying speed v_{S} so that the cableway vehicle 5 can continue to move as smoothly as possible. At the same time, the distance A between two adjacent cableway vehicles 5 is reduced again so that the cableway vehicles 5 can be again moved at a close distance A at the second longitudinal parking track section 41.

Deceleration in the second overlap region 61 can also be realized, for example, by appropriately selecting the sheave diameters of the double pulleys 59 of the tires 57 in the region of the second overlap region 61, or by individually driven tires 57 in the second overlap region 61.

A constant tire conveying speed v_{R} can be set along the parking track curve section 42 between the first overlap region 60 and the second overlap region 61.

For the smoothest possible transition from the parking track curve section 42 to the second longitudinal parking track section 41, it can be provided for a number of tires 57 at the end of the second overlap region 61 to be designed with a slip clutch 49. The slip clutch 49 serves to ensure that, from a moment at which the continuous conveyor 51 acts on the cableway vehicle 5, a tire 57, which also still interacts with the cableway vehicle 5, slips and no longer exerts a propulsion on the cableway vehicle 5. This reliably prevents two drives with different conveying speeds from acting on the cableway vehicle 5 at the same time.

Of course, a number of tires 57 at the beginning of the first overlap region 60 can also be designed so as to include such a slip clutch 49. In particular, this also allows a smooth operation of the parking conveyor 35 in both potential conveying directions.

Instead of slip clutches 49 on the tires 57, a number of tires 57 at the end of the second overlap region 61 could be controlled in terms of the realized tire conveying speed v_{R}. For this purpose, however, these tires 57 must be driven separately. This also allows a smooth transition at the second overlap region 61 from the tire conveying speed v_{R} at the parking track curve section 42 to the continuous conveying speed v_{S} of the continuous conveyor 50 by controlling the rotational speed of these tires 57. This also applies analogously to tires 57 at the beginning of the first overlap region 60. A mixture would also be conceivable, i.e., slip clutches 49 on tires 57 in the second overlap region 61 and controlled tires in the first overlap region 60, or vice versa.

A pusher dog 53 is preferably U-shaped with two protruding legs 62, 63, whereby an engagement region 64 is formed between the legs 62, 63 in an entrainment position of the legs 62, 63, in which a portion of the cableway vehicle 5, for example a portion of the hanger or of the transportation device, comes to rest during operation of the parking storage facility 30 in order to bring the pusher dog 53 into engagement with the cableway vehicle 5. However, the pusher dog 53 can be designed in any other way to realize the engagement. For example, a clutch could also be implemented that is engaged for engagement and disengaged for disengagement. For this purpose, moving parts with their own drive can also be provided on the pusher dog 53 and/or on the cableway vehicle 5.

A roller 65 can also be rotatably mounted on a free axial end of at least one protruding leg 62, 63, as shown in FIG. 4. The roller 65 allows the engagement between the pusher dog 53 and the cableway vehicle 5 and the disengagement between the pusher dog 53 and the cableway vehicle 5 to take place more gently, because the roller 65 of a leg 62, 63 simply rolls off the corresponding portion of the cableway vehicle.

The engagement between the pusher dog 53 and the cableway vehicle 5 can also be improved if at least one protruding leg 63 is rotatably mounted on an axial end of the leg 63 opposite the axial free end so that the leg 63 can be pivoted in particular in the direction of the engagement region 64 (indicated by a dashed line in FIG. 4). A spring element (not shown) can also be provided on the pusher dog 53, which spring element presses the rotatably mounted leg 63 into the entrainment position. The rotatably mounted leg 63 is preferably the rear leg of the pusher dog 53 in the conveying direction R. Such a rotatably mounted leg 63 allows for easily and reliably establishing an engagement between the pusher dog 53 and the cableway vehicle 5. A portion of the cableway vehicle 5, such as a hanger rod 28, which hits the pusher dog 53 from behind in the conveying direction R in the second overlap region 61, folds the leg 63 down and the portion of the cableway vehicle 5 can simply enter the engagement region 64. As soon as the portion is in the engagement region 64, the spring element causes the leg 63 to move back into an entrainment position with the leg 63 protruding. The moved leg 63 can then come to rest against a portion of the cableway vehicle 5, thereby entraining the cableway vehicle 5 in the conveying direction R.

In a parking storage facility 30 having more than two longitudinal parking track sections 40, 41, 43, 44, as in FIG. 3, preferably two adjacent longitudinal parking track sections 40, 41, 43, 44 are each served by a continuous conveyor 51 with a traction means 52. A tire conveyor 51 is provided in each parking track curve section 42 between these longitudinal parking track sections 40. A tire conveyor 51 is also preferably provided at the further parking track curve section 45, if present. However, it is also conceivable for only a first longitudinal parking track section 40 and a second longitudinal parking track section 41 connected thereto via a parking track curve section 42 to be equipped with a parking conveyor 35 embodiment according to the present disclosure, and for other longitudinal parking track sections and parking track curve sections to be equipped with a different parking conveyor 35 embodiment.

The parking track 31 is preferably formed by at least one parking guide rail 36 which, similarly as in FIG. 2, interacts with at least one guide roller 21, 22 on the cableway vehicle 5 in order to guide the cableway vehicle 5 along the parking track 36. The components already provided on the cableway vehicle 5 for operation of the circulating cableway I are thus advantageously employed also for the parking storage facility 30.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. A parking storage facility for cableway vehicles with a meander-shaped parking track for accommodating cableway vehicles, wherein the parking track has at least a first longitudinal parking track section and a second longitudinal parking track section arranged at a distance from one another and wherein the first longitudinal parking track section and the second longitudinal parking track section are connected to each other via a first parking track curve section, wherein a cableway vehicle can be moved along the parking track in a conveying direction by means of a parking conveyor, comprising:
a continuous conveyor of the parking conveyor having a traction means circulating in the conveying direction at a given continuous conveying speed;
a plurality of pusher dogs configured on the traction means, wherein the continuous conveyor is configured to move the cableway vehicle in the conveying direction with at least one of the plurality of pusher dogs and at the continuous conveying speed along the first and second longitudinal parking track sections;
a tire conveyor of the parking conveyor in the first parking track curve section, wherein the tire conveyor has a plurality of driven tires arranged one behind the other in the conveying direction and wherein the tire conveyor is configured to move the cableway vehicle in the conveying direction with the driven tires and at a tire conveying speed along the first parking track curve section;
wherein the continuous conveyor and the tire conveyor overlap in a first overlap region from the first longitudinal parking track section to the parking track curve section and in a second overlap region from the parking track curve section to the second longitudinal parking track section;
wherein the tire conveying speed of the tire conveyor increases in the first overlap region to accelerate the cableway vehicle and, wherein, engagement of the at least one pusher dog with the cableway vehicle is concurrently released;
wherein the tire conveying speed of the tire conveyor decreases in the second overlap region to decelerate the cableway vehicle and, wherein at the same time, at least one of the plurality of pusher dogs comes into engagement with the cableway vehicle.

2. The parking storage facility according to claim 1, further comprising a continuous conveyor having one of:
separate traction means for each of the first longitudinal parking track section and the second longitudinal parking track section; or
a single traction means for both the first longitudinal parking track section and the second longitudinal parking track section.

3. The parking storage facility according to claim 1, further comprising a slip clutch configured to drive at least one tire of the tire conveyor in at least one of the second overlap region and the first overlap region.

4. The parking storage facility according to claim 1, wherein the pusher dog is U-shaped with two protruding legs, whereby an engagement region is formed between the legs in an entrainment position and wherein a portion of the cableway vehicle comes to rest in the engagement region during operation of the parking storage facility in order to bring the pusher dog into engagement with the cableway vehicle.

5. The parking storage facility according to claim 4, further comprising a roller rotatably mounted at the free axial end of at least one protruding leg.

6. The parking storage facility according to claim 4, wherein at least one protruding leg is rotatably mounted on an end of the leg opposite the axial free end and further comprising a spring element on the pusher dog configured to hold the rotatably mounted leg in the entrainment position.

7. A method for storing a cableway vehicle in a parking storage facility for cableway vehicles with a meander-shaped parking track for accommodating cableway vehicles, wherein, for storing, the cableway vehicle is moved with a parking conveyor in a conveying direction along the parking track with at least a first longitudinal parking track section and a second longitudinal parking track section, which are connected to each other via a first parking track curve section, comprising the steps of:
moving the cableway vehicle along the first longitudinal parking track section and the second longitudinal parking track section by a continuous conveyor of the parking conveyor with a traction means circulating at a continuous conveying speed;
engaging the cableway vehicle with at least one of a plurality of pusher dogs on the traction means and entraining the cableway vehicle in the conveying direction with the at least one pusher dogs;
moving the cableway vehicle in the conveying direction along the first parking track curve section with a tire conveyor of the parking conveyor having a plurality of driven tires configured one behind the other in the conveying direction and driven at a tire conveying speed;
increasing the tire conveying speed of the tire conveyor in a first overlap region from the first longitudinal parking track section to the first parking track curve section and accelerating the cableway vehicle relative to the continuous conveying speed;
concurrently releasing the engagement of the at least one pusher dog on the cableway vehicle;
reducing the tire conveying speed of the tire conveyor in a second overlap region from the first parking track curve section to the second parking track longitudinal section and decelerating the cableway vehicle; and
concurrently bringing at least one of the plurality of pusher dogs into engagement with the cableway vehicle.

8. The method according to claim 7, further comprising at least one of the steps of:
moving the cableway vehicle in the first longitudinal parking track section and in the second longitudinal parking track section in each case by a continuous conveyor comprising its own traction means for the first longitudinal parking track section and the second longitudinal parking track section; and
moving the cableway vehicle in the first longitudinal parking track section and in the second longitudinal parking track section by a continuous conveyor with the same traction means for the first longitudinal parking track section and the second longitudinal parking track section.

9. The method according to claim 7, wherein the tire conveying speed is kept constant after the first overlap region up to the second overlap region.
